(19) United States
(12) Patent Application Publication
(10) Pub. No.: US 2008/0229589 A1
(43) Pub. Date: Sep. 25, 2008

(54) Power tool having improved visibility of the cutting area

(76) Inventor: Danny Bone, Langley Moor (GB)

Correspondence Address: THE BLACK & DECKER CORPORATION, 701 EAST JOPPA ROAD, TW199, TOWSON, MD, 21286, US

(21) Appl. No.: 11/728,275

(22) Filed: Mar. 23, 2007

(51) Int. Cl. B23D 49/10

(52) U.S. Cl. 30/392; 33/348

(57) ABSTRACT

An electrically powered hand operated cutting tool comprising a housing for accommodating a motor having an output shaft coupled to a gearbox, said gearbox being arranged to convert rotary output motion of the motor into reciprocating motion of a shaft, said shaft having a clamp disposed at one end for clamping a saw blade thereto, and a footplate for engaging with a work-piece during use, said footplate comprising an opening through which a blade disposed in the clamp can pass, wherein the tool further comprises a camera and display screen, during use, said camera being arranged to take real-time images of a blade engaging with a work-piece, and wherein the display screen displays the real-time images, said display screen being disposed on the housing so as to be visible to an operator.

### FIELD OF THE INVENTION

The present invention is for a power tool having improved visibility of an area of a work-piece being cut or worked on by the tool.

Embodiments of the present invention are described herein with reference to a jigsaw. However, the present invention is not limited to jigsaws and can also be used on any other type of hand operated electrically powered tool.

### BACKGROUND OF THE INVENTION

Jigsaws are well known types of power tools used to cut a work-piece. Typically, and with reference to FIG. 1, such cutting tools 10 comprise an electrically powered motor 12 which is coupled to a gearbox 14. The gearbox is arranged to translate rotational output motion transmitted by the motor into reciprocating motion of a saw blade 16, thereby providing a cutting action. Thus, the output of the gearbox generally comprises a reciprocating shaft 18 which has a clamp 20 on one end in which a saw blade can be disposed. During use, the blade extends through an aperture or opening in a footplate 22 which is in engagement with the work-piece WP.

The gearbox's configuration usually means that the jigsaw's saw blade extends down from a housing in which the motor and gearbox are disposed. Thus, with reference to FIG. 1, the operator's view of the work-piece being cut is obscured by the housing. As a result, to view the cut area, the operator has to position their eye either to one side of the housing, or in front of the housing to obtain a proper view of the work-piece being cut and to maintain the direction of cut along a predetermined cut line.

Various attempts to improve known jigsaws such that the view for the operator of the cut line is less obscured have been proposed.

For instance, GB 2399314 discloses a jigsaw, wherein an upper part of the jigsaw's housing comprises a circular track surrounded by a circular rubber grip, and a steering knob is rotatably mounted to the circular track. The remaining part of the circular track not occupied by the steering knob defines an aperture through which a user of the jigsaw can view the location at which the jigsaw blade cuts through a work-piece. Furthermore, BLACK AND DECKER (rtm) produce and sell a jigsaw under the SITELINE trade name which comprises a vertical slot channel running down the front face of the gearbox housing to help improve visibility of the cut area.

U.S. Pat. No. 3,504,716 describes a portable power tool, such as a sabre or circular saw, to act on a work-piece, comprising a guide having an image transmitting conduit mounted on the power unit with the image pickup end positioned to pick up the image of the work-piece at a point along the path of travel of the terminal device relative to the work-piece. The image transmitting conduit consists of a bundle of transparent or plastic fibres coated with a glass or plastic covering of lower refractive index, the bundle being protected by a covering of epoxy resin. The lower end of the conduit is slotted to receive the saw blade and engages the work-piece so that at the image viewing end an area represents the blade which can be aligned with the image.

### SUMMARY OF THE INVENTION

The present invention provides an electrically powered hand operated cutting tool comprising, a housing for accommodating a motor having an output shaft coupled to a gearbox, said gearbox being arranged to convert rotary output motion of the motor into reciprocating motion of a shaft,

said shaft having a clamp disposed at one end for clamping a saw blade thereto, and a footplate for engaging with a work-piece during use,
said footplate comprising an opening through which a blade disposed in the clamp can pass, wherein the tool further comprises a camera and display screen, said camera being arranged to collect and/or provide real-time images of a blade engaging with a work-piece,
and wherein the display screen displays the real-time images, said display screen being disposed on the housing so as to be visible to an operator.

Advantageously, the operator can cut the work-piece and have a good view of the cutting area where the blade engages with the work-piece from a viewpoint which is more comfortable or convenient. Furthermore, a clear image on the blade engaging the work-piece can be obtained in magnified form thereby improving the accuracy of the cut.

Preferably, an illumination device is arranged to illuminate the work-piece at a point where a blade engages the work-piece. Thus, the clear image of the work-piece can be displayed.

Preferably, the illumination device transmits light in the near infrared region of the electromagnetic spectrum, and the camera is arranged to detect light in the near infrared. Thus, the operator's eye, which would not under normal circumstances detect radiation in the near infrared, does not detect the illumination, which could be so intense as to dazzle the user.

Preferably, the display screen is disposed on the housing next to a manual gripping portion of the housing. Thus, an ergonomic position of the display can be achieved where easy adjustment of the display's parameters or position can be made without having to release the tool.

Preferably, the display is preferably hingedly disposed on the housing. As a result, the display can be moved into a position which maximises its visibility.

Preferably, the display can be moveable between a stowed position and a displaying position. Thus, the display can be stowed away when not in use thereby providing a means for keeping the screen clean from dust or debris.

Preferably, the display screen can be arranged to be flush with a portion of the housing accommodating the display when the display is in the stowed position. As a result, the display screen can be arranged to be stowed in a position where it does not interrupt the silhouette of the tool. Furthermore, the screen can be arranged so that it is operable in the flush stowed position.

Preferably, the camera and display are powered by a dedicated battery, thereby providing power means which are independent of the power source for the tool. As a result, the camera and display can be operated without having to switch on the tool.

Preferably, a line is displayed on the display which corresponds to the cut direction of a blade disposed in the clamp. Thus, accurate cutting can be achieved when the displayed line is superimposed over a line marked on the work-piece.

### BRIEF DESCRIPTION OF THE DRAWINGS

An embodiment of the present invention is now described by way of example with reference to the accompanying drawing, of which:

FIG. 1 is a schematic diagram of a conventional jigsaw;

FIG. 2 is a schematic diagram of a jigsaw embodying the present invention; and

FIG. 3 is a schematic view of a display screen of the jigsaw shown in FIG. 2.

### DETAILED DESCRIPTION OF THE INVENTION

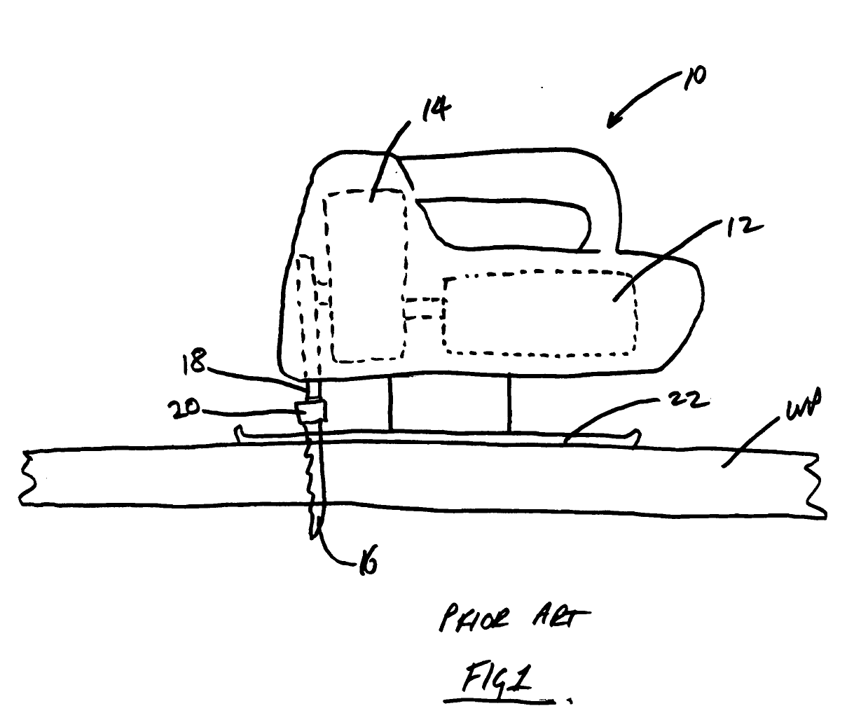

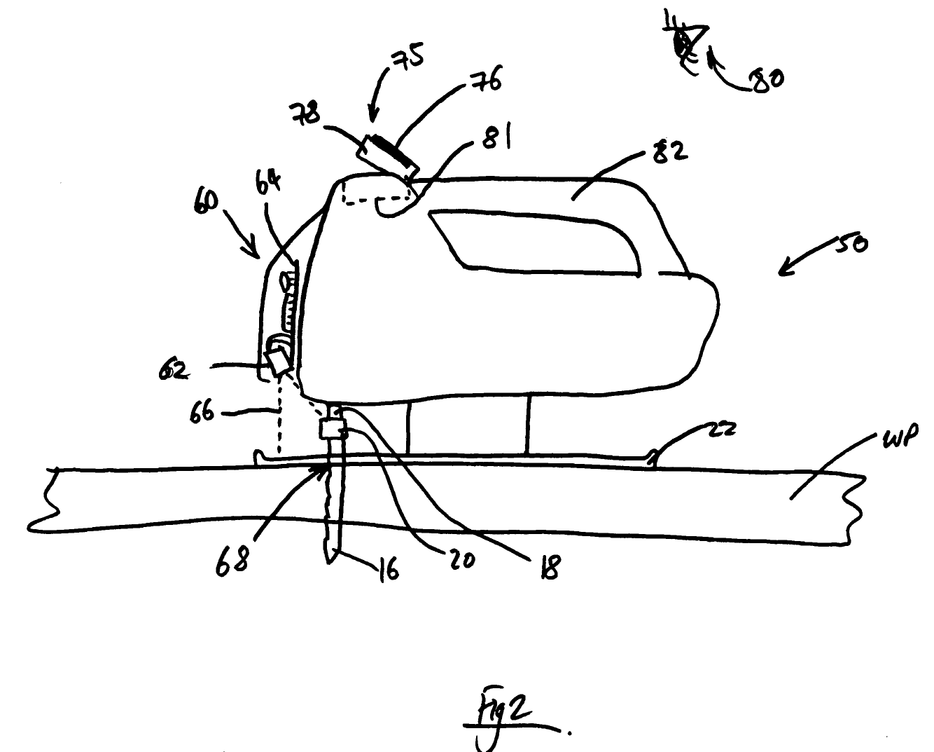

Referring to FIG. 2, a jigsaw 50 embodying the present invention is shown. Components of this jigsaw which are common with the tool shown in FIG. 1 have been assigned the same indication numerals. The jigsaw shown schematically in FIG. 2 comprises a camera module 60 and display screen 75.

The camera module comprises a CCD unit 62 which comprises a lens in front of the CCD to image a scene onto the CCD's array. The output from the CCD is coupled to a PCB 64 for processing the raw CCD data. The processed data is sent to a display unit 75 for displaying the image to a user 80.

The camera has a field of view 66 which is arranged to include the point 68 where the saw blade 16 engages with the work-piece WP. The point 68 should be arranged to be towards one end of the field of view such that the intended cut line is visible in front of the saw blade. In this way, the image displayed on the display screen includes the leading edge of the saw blade and any mark on the work-piece used to indicate the intended cut line.

The camera module also comprises one or more LEDs to illuminate the point 68 and immediately surrounding area of the work-piece. Typically, CCD arrays are sensitive to near infrared radiation. Thus, the illuminating LEDs can be arrange to transmit light in this region of the spectrum (between 800 nm to 1100 nm, for instance). This can be beneficial because the human eye is not sensitive to radiation in this region. Thus, the work-piece is illuminated for the camera without using bright visible lights which could cause glaring of the operator's vision.

The display 75 comprises a display screen 76 mounted on a hinged module 78. The module is attached to the jigsaw body by a hinge such that it can retract into a recess 80 formed in the body. Thus, when folded into the recess 81 the display screen 76 is arranged to be flush with the body of the jigsaw. Furthermore, the display module 75 can be located close to or next to a gripping portion 82 of the jigsaw's body which is used by the operator to grip and operate the jigsaw. As a result, the display module is close to hand and the operator can manipulate the screen without having to release their grip on the tool. Push buttons can be provided on the display module for adjusting the display's brightness or contrast.

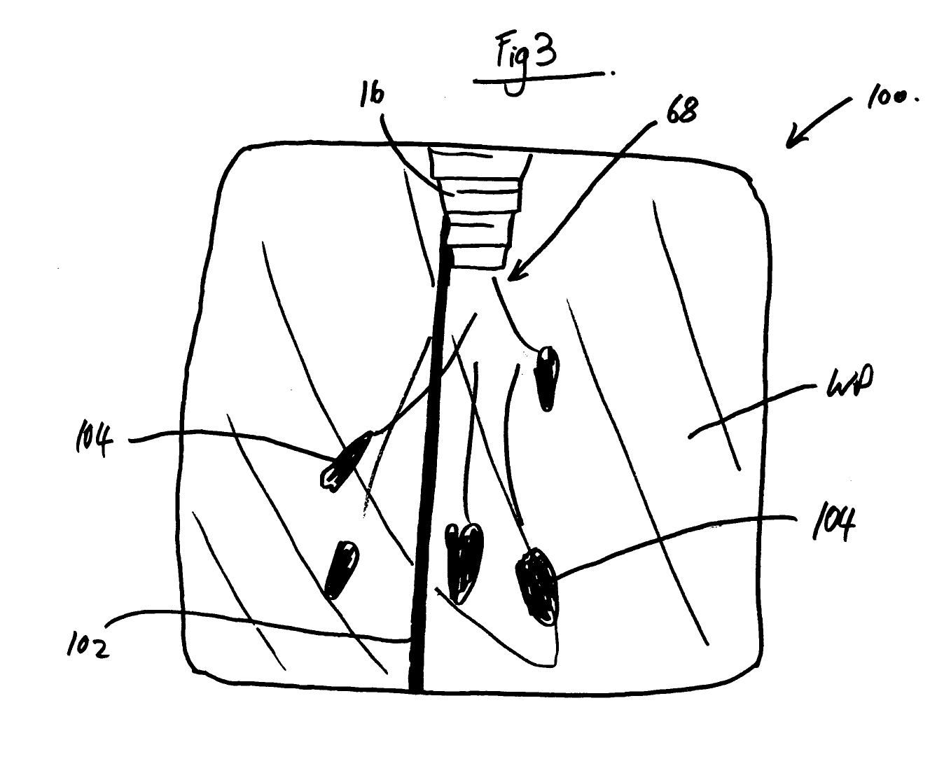

Referring now to FIG. 3, a view 100 of the display screen 76 is shown during operation. The point 68 of where the saw blade 16 engages with the work-piece WP is displayed. Also, a pre-drawn pencil line 102 indicating the cut line is displayed. Debris 104 ejected from the cutting blade is visible in the display. In practice, we have found that the debris does not form a significant obscurant to the pencil line when cutting soft wood, such as pine. Of course, the usual dust/debris removal schemes can be employed to ensure debris does not cause any significant problem with respect to the visibility of the cut line.

The display can be enhanced by providing a superimposed line in the display. This superimposed line should be in line with the direction of cut. The superimposed line can be added after the CCD camera data is processed, or a physical line can be drawn on the screen of the display. Alternatively, a cross-hair line can be included in the camera's objective lens.

A blower can be utilised to keep debris from collecting on the objective lens of the camera, or from collecting on the illuminating LEDs. The blower can be coupled to an air fan arranged on the motor's output shaft. Air exhausted from the fan can be directed by channels formed in the moulded housing, exiting the housing via a nozzle or output port disposed close to the camera.

While the embodiment described above illustrates the camera module and display as components of a jigsaw, the camera and display can be used on a myriad of powered tools; such as, but not limited to, a circular saw, a router, a spiral bit cutter, reciprocating saw, vegetation pruner and/or shearer, a pole saw, a chainsaw.

Other embodiments can be envisaged by the skilled person without leaving the scope of the present invention. For instance, the camera can be linked to the display screen via a wireless link using the BLUETOOTH protocol. Furthermore, the camera and/or display might be detachable from the housing for added enhancement of the tool. As a result, the camera might be used to provide the operator with vision access to areas of a work area which might not otherwise be unavailable—the camera might act as an inspection tool, for example.

I claim:

1. A powered hand operated tool comprising:
a housing;
a motor disposed within said housing;
a working instrument connected to said motor; and,
a camera connected to a display screen, said camera being oriented to see said working instrument engage a work-piece, and wherein display screen is disposed on the housing so as to be visible to an operator.

2. The tool of claim 1 further comprising an illumination device positioned to illuminate said working instrument engaging said work-piece.

3. The tool of claim 2, wherein the illumination device transmits light in the near infrared region of the electromagnetic spectrum, and wherein the camera is arranged to detect light in the near infrared region.

4. The tool of claim 1, wherein the display screen is disposed on the housing near a manual gripping portion of the housing.

5. The tool of claim 4, wherein the display is hingedly disposed on the housing.

6. The tool of claim 1, wherein the display is moveable between a stowed position and a displaying position.

7. The tool of claim 6, wherein the display is flush with a portion of the housing when in the stowed position.

8. The tool of claim 1, wherein a line is displayed on the display which corresponds to a travel direction of said working instrument.
